(19) United States
(12) Patent Application Publication
(10) Pub. No.: US 2019/0056127 A1
(43) Pub. Date: Feb. 21, 2019

(54) ENCLOSED SPACE AIR CONDITIONING SYSTEMS

(71) Applicant: Otis Elevator Company, Farmington, CT (US)

(72) Inventors: Zbigniew Piech, Cheshire, CT (US); Wojciech Szelag, Poznan (PL); Cezary Jedryczka, Lniano (PL); Tadeusz Pawel Witczak, Farmington, CT (US); Daniel P. Archibald, Harrison, NY (US)

(21) Appl. No.: 15/680,722

(22) Filed: Aug. 18, 2017

(51) Int. Cl. F24F 5/00; F24F 11/00; B66B 11/02

(52) U.S. Cl. CPC F24F 5/0042; F24F 11/0034; B66B 11/024; F24F 11/0012; F24F 5/0092; F24F 11/0078

(57) ABSTRACT

Enclosed space air conditioning systems having air conditioning module(s) with an enclosure defining a cavity, a thermoelectric element arranged to condition air within the cavity, an air direction mechanism to direct air from the cavity into an enclosed space, and an electronics package for controlling the air direction mechanism and the thermoelectric element, the electronics package including a detection element to detect when an occupant in the enclosed space is in proximity of the at least one air conditioning module. The electronics package is configured to activate the air direction mechanism and/or the thermoelectric element when the occupant is detected, deactivate the activated air direction mechanism and/or thermoelectric element when the occupant is no longer in proximity, and/or activate the air direction mechanism and/or the thermoelectric element to maintain an enclosed space preset condition.

### BACKGROUND

The subject matter disclosed herein generally relates to air conditioning systems and, more particularly, to air conditioning systems for enclosed spaces.

Enclosed spaces, such as rooms, offices, cubicles, elevator cars, etc. typically have air conditioning systems arranged to provide conditioned air to the entire space. The air supply is typically provided by one or more vents that are connected to ducting. The air is cooled remotely from the vents and blown into and through the ducting and then the conditioned air enters the enclosed space through the vents. The air is typically conditioned by a heat exchanger and/or heat pump system that cools all of the air blown through the vents and into the enclosed space.

### SUMMARY

According to some embodiments, enclosed space air conditioning systems are provided. The enclosed space air conditioning systems include at least one air conditioning module having an enclosure defining a cavity, a thermoelectric element arranged within the cavity and configured to condition air within the cavity, an air direction mechanism controllable to direct air from the cavity into an enclosed space, and an electronics package configured to control the air direction mechanism and the thermoelectric element, the electronics package including a detection element configured to detect when an occupant in the enclosed space is in proximity of the at least one air conditioning module. The electronics package is configured to at least one of (i) activate at least one of the air direction mechanism and the thermoelectric element when the occupant is detected in proximity to the at least one air conditioning module, (ii) deactivate the activated air direction mechanism and/or thermoelectric element when the occupant is no longer detected in proximity to the at least one air conditioning module, and (iii) activate at least one of the air direction mechanism and the thermoelectric element to maintain an enclosed space preset condition.

In addition to one or more of the features described above, or as an alternative, further embodiments of the enclosed space air conditioning systems may include that the air direction mechanism comprises at least one of (i) a fan located within the cavity and arranged to blow air out of the enclosure and into the enclosed space and (ii) a controllable vent forming a portion of the enclosure and arranged to open and close to enable air to pass from the cavity of the enclosure into the enclosed space.

In addition to one or more of the features described above, or as an alternative, further embodiments of the enclosed space air conditioning systems may include that the at least one air conditioning module comprises a first air conditioning module and a second air conditioning module, wherein the first air conditioning module includes a first module enclosure having a first module air direction mechanism and a first module thermoelectric element within the first module enclosure and the second air conditioning module includes a second module enclosure having a second module air direction mechanism and a second module thermoelectric element within the second module enclosure.

In addition to one or more of the features described above, or as an alternative, further embodiments of the enclosed space air conditioning systems may include that the first air conditioning module is connected to the second air conditioning module and wherein a first module cavity within the first module enclosure is fluidly connected to a second module cavity within the second module enclosure.

In addition to one or more of the features described above, or as an alternative, further embodiments of the enclosed space air conditioning systems may include that the electronics package includes a temperature sensor arranged to detect an air temperature in proximity to the at least one air conditioning module.

In addition to one or more of the features described above, or as an alternative, further embodiments of the enclosed space air conditioning systems may include a plurality of air conditioning modules.

In addition to one or more of the features described above, or as an alternative, further embodiments of the enclosed space air conditioning systems may include that at least two air conditioning modules are connected to each other, wherein the connection between the at least two air conditioning modules at least one of electrically and communicatively connects the at least two air conditioning modules.

In addition to one or more of the features described above, or as an alternative, further embodiments of the enclosed space air conditioning systems may include that the electronics package is located within the enclosure, wherein the electronics package includes a proximity detector arranged to detect a presence of an occupant in proximity of the proximity detector.

In addition to one or more of the features described above, or as an alternative, further embodiments of the enclosed space air conditioning systems may include that the electronics package includes a communication device arranged to at least one of communicate with a user device and detect the user device.

In addition to one or more of the features described above, or as an alternative, further embodiments of the enclosed space air conditioning systems may include that the electronics package receives user preferences from the user device and is configured to transmit a location or position to the user device to indicate a location or position within the enclosed space that is pre-conditioned in accordance with the user preferences.

In addition to one or more of the features described above, or as an alternative, further embodiments of the enclosed space air conditioning systems may include that the air conditioning module includes a second enclosure arranged on an opposing side of the enclosure when the enclosure is installed relative to the enclosed space, the second enclosure defining a second cavity therein.

In addition to one or more of the features described above, or as an alternative, further embodiments of the enclosed space air conditioning systems may include that the thermoelectric element has a surface exposed to the cavity and a surface exposed to the second cavity.

In addition to one or more of the features described above, or as an alternative, further embodiments of the enclosed space air conditioning systems may include that at least one of the surfaces of the thermoelectric element includes thermal transfer features arranged to increase a thermal transfer between the thermoelectric element and air.

In addition to one or more of the features described above, or as an alternative, further embodiments of the enclosed space air conditioning systems may include an air supply cavity fluidly connected to the cavity to supply air into the cavity of the enclosure.

In addition to one or more of the features described above, or as an alternative, further embodiments of the enclosed space air conditioning systems may include a blower connected to the air supply cavity, wherein the blower is operable to blow air into the cavity.

According to some embodiments, enclosed spaces are provided. The enclosed spaces include an enclosed space air conditioning system forming at least a portion of a ceiling of the enclosed space. The enclosed space air conditioning system includes at least one air conditioning module having an enclosure defining a cavity, an air direction mechanism located arranged to direct air out of the enclosure and into an enclosed space, a thermoelectric element arranged within the cavity and configured to condition air within the cavity, and an electronics package configured to control the air direction mechanism and the thermoelectric element, the electronics package including a detection element configured to detect when an occupant in the enclosed space is in proximity of the at least one air conditioning module. The electronics package is configured to at least one of (i) activate at least one of the air direction mechanism and the thermoelectric element when the occupant is detected in proximity to the at least one air conditioning module, (ii) deactivate the activated air direction mechanism and/or thermoelectric element when the occupant is no longer detected in proximity to the at least one air conditioning module, and (iii) activate at least one of the air direction mechanism and the thermoelectric element to maintain an enclosed space preset condition.

In addition to one or more of the features described above, or as an alternative, further embodiments of the enclosed spaces may include that the enclosed space is a cab of an elevator car.

In addition to one or more of the features described above, or as an alternative, further embodiments of the enclosed spaces may include that the enclosed space air conditioning system comprises a plurality of air conditioning modules.

In addition to one or more of the features described above, or as an alternative, further embodiments of the enclosed spaces may include that each air conditioning module includes a dedicated electronics package located within the enclosure of the air conditioning module.

In addition to one or more of the features described above, or as an alternative, further embodiments of the enclosed spaces may include that detection of the occupant comprises communication between the electronics package and a user device of the occupant, wherein personal preferences are received at the electronics package and the electronics package controls the at least one air conditioning module to condition air in accordance with the personal preferences.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of an enclosed space that can incorporate embodiments of the present disclosure;

FIG. 3A is an isometric illustration of an enclosed space air conditioning system in accordance with an embodiment of the present disclosure;

FIG. 3B is a cross-section illustration of the enclosed space air conditioning system of FIG. 3A as viewed along the line B-B shown in FIG. 3A;

FIG. 3C is an enlarged illustration of an air conditioning module of the enclosed space air conditioning system of FIG. 3A;

FIG. 4 is a schematic illustration of an enclosed space having an enclosed space air conditioning system in accordance with an embodiment of the present disclosure installed relative thereto;

FIG. 5 is a schematic illustration of detection zones of an enclosed space air conditioning system in accordance with an embodiment of the present disclosure;

FIG. 6 is an isometric illustration of another embodiment of an enclosed space air conditioning system in accordance with the present disclosure; and

FIG. 7 is a side view illustration of airflow through an enclosed space air conditioning system in accordance with an embodiment of the present disclosure.

### DETAILED DESCRIPTION

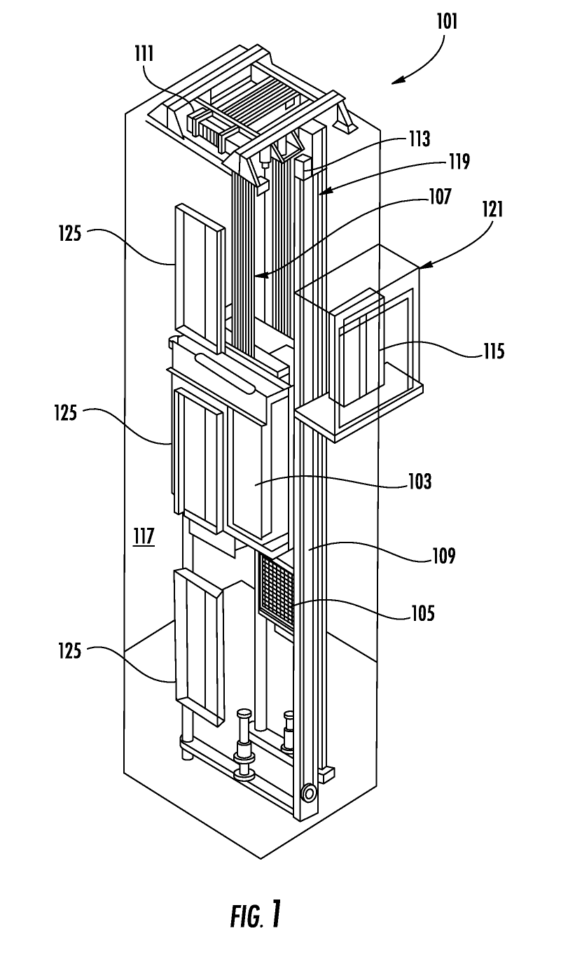

FIG. 1 is a perspective view of an elevator system 101 including an elevator car 103, a counterweight 105, roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft, such as hydraulic or ropeless, may employ embodiments of the present disclosure. FIG. 1 is merely a non-limiting example presented for illustrative and explanatory purposes.

Turning now to FIG. 2, an enclosed space 201 is shown. The enclosed space 201 may be representative of an interior of an elevator car (e.g., elevator car 103) or may be any enclosed space, such as an office, a hallway, a room, etc. As illustratively shown in FIG. 2, two occupants 203a, 203b are within the enclosed space 201. To cool the enclosed space 201 and provide comfortable air temperature, humidity, etc. (i.e., air conditioning) a vent 205 is provided within a ceiling 207 and arranged to blow or supply air conditioned air 209 to the occupants 203a, 203b. Such arrangement can provide highly cooled or treated air in proximity to the vent 205 but as a distance away from the vent 205 increases, the conditioning of the air and/or the effectiveness of the air conditioning will decrease.

As will be appreciated by those of skill in the art, because of the changes in location of an occupant and/or power requirements or constraints, air conditions for an occupant may not be consistent throughout the enclosed space. Alternatively, if an occupant 203a, 203b must remain in one location within the enclosed space, but is not close to the vent 205, the occupant may become uncomfortable. That is, a fixed source or vent of treated or air conditioned air may cause discomfort with one or more occupants within an enclosed space. Further, such fixed vent location can limit the efficiency of such air conditioning systems, as a single vent with need to treat an entire space (e.g., enclosed space 201).

Some embodiments provided herein are directed to addressing an occupant's needs to feel thermal comfort and air freshness within confined public spaces e.g. elevator car, office cubical, etc., referred to herein as “enclosed space(s).” Some embodiments of the present disclosure are directed to providing improved efficiency air conditioning systems for enclosed spaces. Typically, the air temperature in an enclosed space (e.g., an elevator car) as well as air circulation is regulated by one central air conditioning unit or only by central fan, with air supplied through a single or limited number of vents. Such air conditioning systems typically work independently of occupancy of the enclosed space, and all the occupants are subjected to the same air treatment (e.g., circulation, temperature, humidity, etc.). As such, some embodiments provided herein are directed to offering individualized environmental comfort for each occupant separately, depending on an occupant's settings or preferences and an ambient air condition of air around the occupant's location in the enclosed space. Other embodiments of the present disclosure are directed to automated, occupant-specific air conditioning within enclosed spaces. Further, embodiments provided herein can include features of both personalized and automated systems, without departing from the scope of the present disclosure.

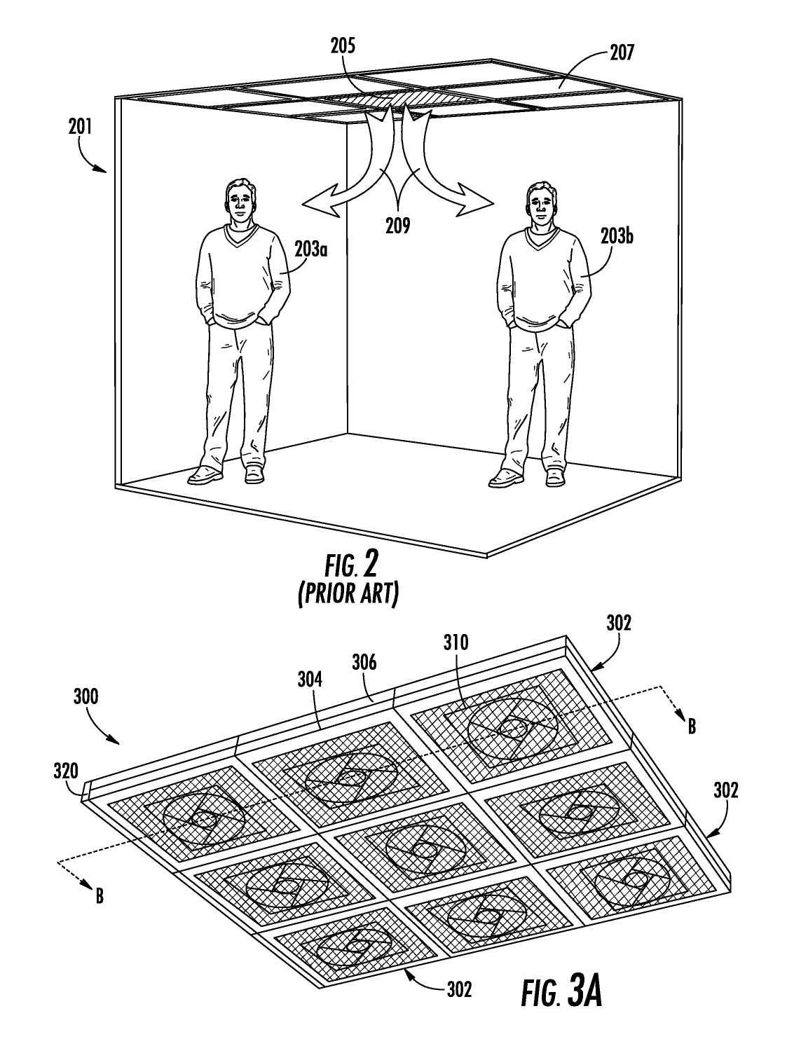

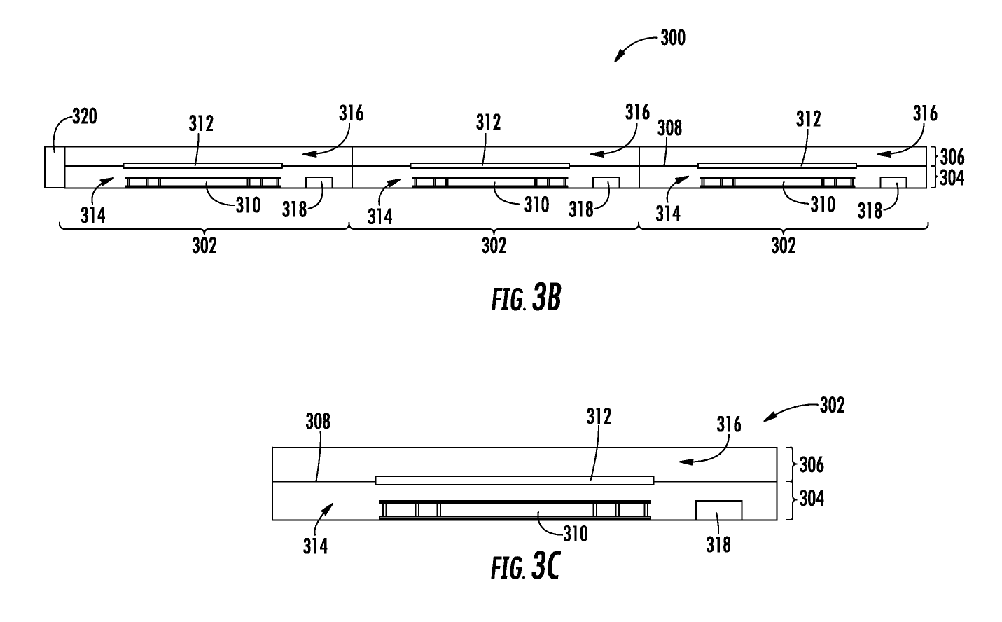

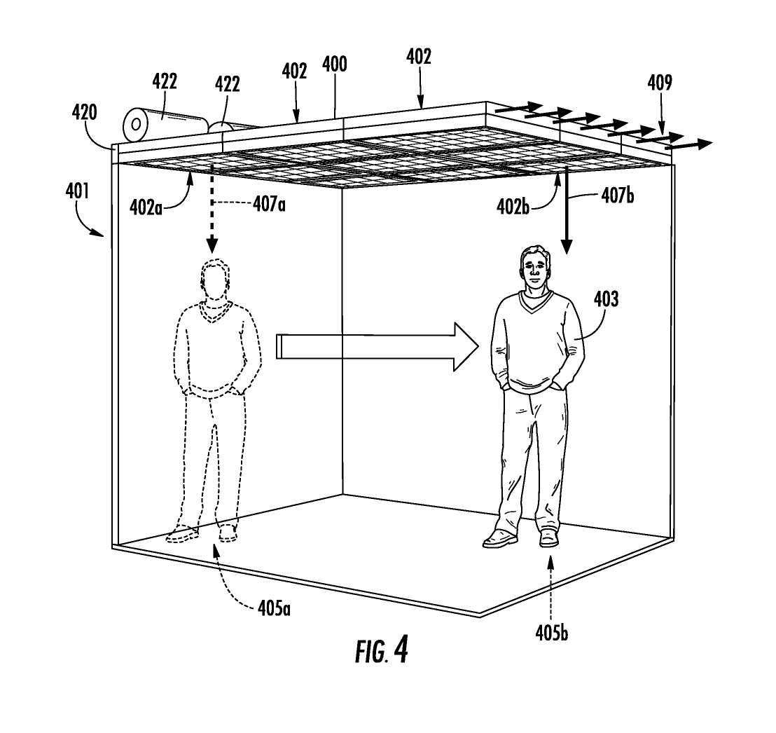

Turning now to FIGS. 3A-3C, schematic illustrations of a customizable enclosed space air conditioning system 300 in accordance with a non-limiting embodiment of the present disclosure are shown. FIG. 3A is an isometric illustration of the enclosed space air conditioning system 300 as viewed from below the enclosed space air conditioning system 300. FIG. 3B is a cross-sectional illustration of the enclosed space air conditioning system 300 as viewed along the line B-B shown in FIG. 3A. FIG. 3C is a side view illustration of an air conditioning module 302 of the enclosed space air conditioning system 300 shown in FIG. 3A.

As shown in FIG. 3A, the enclosed space air conditioning system 300 is formed from a plurality of air conditioning modules 302. In some embodiments, the enclosed space air conditioning system 300 can form a ceiling of an enclosed space, e.g., a ceiling of an elevator car, cubicle area, hallway, etc. As such, the air conditioning modules 302, in some embodiments, may be configured as ceiling tiles or panels, as will be appreciated by those of skill in the art. The air conditioning modules 302 are individual elements that are combinable to form the enclosed space air conditioning system 300. That is, although the enclosed space air conditioning system 300 of FIG. 3A is shown with nine air conditioning modules 302, those of skill in the art will appreciate that enclosed space air conditioning systems of the present disclosure can be formed from one or more, or any desired number and/or shape, air conditioning modules to create a desired shape or arrangement of air conditioning modules.

Each air conditioning module 302, in the embodiment of FIGS. 3A-3C, includes a first enclosure 304 and a second enclosure 306. As shown, the first enclosure 304 and the second enclosure 306 are stacked or joined to form the air conditioning module 302. In some embodiments, and as shown in the present illustrations, the first enclosure 304 and the second enclosure 306 share a common wall 308. In the present embodiment, the first and second enclosures 304, 306 form a unitary body or structure. However, in other embodiments, the first and second enclosures may be separate structures that are fixedly attached or connected, such as by adhesives, fasteners, welding, or other means of attachment or connection, and can be permanently or removably attached. In some embodiments, the connection between adjacent air conditioning modules 302 can provide electrical and/or power connections and/or communication between and/or through the various air conditioning modules 302. In one non-limiting example, a power and communication connection can enable a remote (e.g., independent) control unit to communicate with the various air conditioning modules 302 of the enclosed space air conditioning system 300.

The first enclosure 304 houses an air direction mechanism 310 that is arranged to direct air from one or both of the first and second enclosures 304, 306 into an enclosed space. The air direction mechanism 310 can be a fan, a vent, or a combination thereof. Air that is conveyed through the air direction mechanism 310 and into the enclosed space can be treated by a thermoelectric element 312. Each air conditioning module 302 may include a thermoelectric element 312 for treating the air within one or both of the enclosures 304, 306 that is blown into the enclosed space by the air direction mechanism 310. In some embodiments, and as shown in FIG. 3C, the first enclosure 304 defines a first cavity 314 and the second enclosure 306 defines a second cavity 316. The cavities 314, 316 can receive air from an external source, as described herein, which is then treated by the thermoelectric element 312 and blown into an enclosed space by the air direction mechanism 310.

In some embodiments, such as that shown in FIGS. 3A-3B, adjacent air conditioning modules 302 can be connected such that a continuous array of first cavities 314 and/or second cavities 316 are formed within the enclosed space air conditioning system 300. The connection can be by any means as will be appreciated by those of skill in the art. Modularity can be achieved through using a bracket-type construction and/or connection mechanism that attaches and connects adjacent air conditioning modules. The brackets can be located above the second enclosures 306, and thus not be visible from within the enclosed space. Further, in some embodiments, each air conditioning module can include connectors (e.g., slot-and-groove, pin-and-lock, etc.).

The thermoelectric element 312 is a device arranged to change an air temperature of air in contact with and/or near the thermoelectric element 312. In some arrangements, the thermoelectric element 312 can provide heating or cooling to air to thus change a temperature of air that is supplied into an enclosed space by the air conditioning module. In some embodiments, the thermoelectric element 312 is a Peltier device or other solid state refrigerator and/or solid state heat exchanging thermos-element. In some embodiments, the thermoelectric element 312 may be any type of heating and/or cooling device, including, but not limited to, a hot/chilled water/steam system, refrigerant-based system, or any other known heating/cooling system. Application of a directional current to the thermoelectric element 312 can cause either heating or cooling to air that is in proximity to the thermoelectric element 312, as will be appreciated by those of skill in the art.

Each air conditioning module 302 includes an electronics package 318. As shown, the electronics package 318 of each air conditioning module 302 is housed within the first enclosure 304, although the electronics package 318 can be located in the second enclosure 306, or a portion of the electronics package 318 can be located external to the specific air conditioning module 302. The electronics package 318 can include various electronic and/or electrical components to enable control of the associated air conditioning module 302. In some embodiments, the electronics package 318 includes a processor, memory, control logic, electrical switches, etc. to enable operation as described herein. The electronics package 318 can control operation of the air direction mechanism 310, controlling fan speed and also operational state (e.g., on/off) and/or of the thermoelectric element 3. The electronics package 318 can also include sensors and/or detection elements to determine the presence of an occupant located in proximity of the specific air conditioning module 302. Further, the electronics package 318 can include communications components able to communicate with remote devices, such as controllers, user devices (e.g., smart phones, smart badges, etc.), or other electronic devices and/or control elements. Accordingly, the electronics package 318 can include a communications device, such as a Bluetooth and/or Near-Field chip or component to enable communication with devices local to the electronics package 318.

The electronics package 318 of a given air conditioning module 302 can selectively operate the air direction mechanism 310 and/or the thermoelectric element 312 to provide conditioned air to a space proximate the specific air conditioning module 302. The electronics package 318 can control a direction of current applied to the thermoelectric element 312 to achieve a desired air conditioning effect (e.g., heating or cooling). Such operation can be based on proximity and/or detection of an occupant relative to the air conditioning module 302, as detected by the electronics package 318. In other embodiments, the operation of the air conditioning module 302 can be triggered by a communication between the electronics package 318 and a user device, such as a smart phone or other personal electronic device that may be carried by an occupant. Such communication can be achieved through near-field communication protocols or other similar data communication systems and/or operations as will be appreciated by those of skill in the art. The personal communication of such systems can allow preset temperatures and/or other comforting parameters to be provided to the electronics package 318 and thus enable customized control to achieve the desired comfort parameters of the user. In some such embodiments, the personal preferences can be received at the electronics package 318 prior to the user entering an enclosed space, and thus conditioning of the air can be performed to achieve the desired qualities for when the user arrives into the enclosed space. Further still, in some embodiments, the air conditioning module 302 can be controlled by a remote or independent control element or device (e.g., a computer) that monitors occupants within an enclosed space, such as security and/or building management systems, as will be appreciated by those of skill in the art.

In some embodiments, the electronics package 318 is in communication with a controller or other system that is associated with the associated enclosed space (e.g., thermostat). In such embodiments, the electronics package 318 can be used to control the respective air conditioning module 302 to maintain a preset temperature or other air conditioning state. That is, in some embodiments, no occupant is required to be present within the enclosed space to activate operation of the air conditioning module 302. Further, in some such embodiments, both an enclosed space preset condition can be maintained by one or more the air conditioning modules 302 and adjustments to the enclosed space preset condition can be performed based on detection of the presence of an occupant within the enclosed space.

In operation, one or more air conditioning modules 302 will operate the air direction mechanisms 310 therein to blow air into an enclosed space. When the air direction mechanism 310 is operated, the air is pulled (or pushed) through the air direction mechanism from within one or both of the first and second cavities 314, 316. Further, in some arrangements, with multiple air conditioning modules 302 adjoining to form a multiple-module-enclosed space air conditioning system 300, the cavities of the various modules may be fluidly connected or open to each other such that when a single air direction mechanism 310 is operated, the air direction mechanism 310 may draw air from any and/or all of the cavities of the various air conditioning modules 302.

As shown in FIGS. 3B-3C, the thermoelectric element 312 can be exposed to both the first cavity 314 and the second cavity 316. In some configurations, the portion of the thermoelectric element 312 exposed to the second cavity 316 can operate as a thermal energy dispersal such that thermal energy is removed from air within the first cavity 314 and expelled into the second cavity 316.

In the embodiment of FIGS. 3A-3C, the enclosed space air conditioning system 300 includes an air supply cavity 320. The air supply cavity 320 can be a duct or other structure to supply air into the cavities 314, 316 of the various air conditioning modules 302 of the enclosed space air conditioning system 300. In some embodiments, a blower or other air supply device can be arranged to provide a supply of air into one or both of the cavities of the enclosed space air conditioning system 300, and in some embodiments, such supplied air can be preconditioned. Such preconditioning can be employed for adjusting a humidity level of air and/or flow volume that is available to one or more air conditioning modules 302 of the enclosed space air conditioning system 300.

In some embodiments, the air conditioning modules 302 include additional elements and features, without departing from the scope of the present disclosure. For example, in some embodiment, one or both of the first and second enclosures 304, 306 can include filters or other structures to provide additional air quality conditioning. In some such embodiments, a portion of the first and second enclosures 304, 306 can include a particular lattice structure and/or chemical/compound that provides treatment to air (e.g., remove particulates, etc.). Further, in some embodiments, the electronics packages 318 may include temperature sensors arranged to detect a temperature of air in proximity to the air conditioning module 302 in which the temperature sensor is located. As such, localized thermal management can be achieved. Further, in some embodiments, such sensors can be used to detect other types of air quality characteristics, including, but not limited to humidity levels.

Turning now to FIG. 4, a schematic illustration of an enclosed space 401 having an enclosed space air conditioning system 400 arranged relative thereto is shown. The enclosed space 401 can be an elevator car cab (e.g., interior passenger space of an elevator car) or other enclosed space where it may be desirable to provide air conditioning (e.g., heating, cooling, humidity control, air flow, etc.). As shown, an occupant 403 is located within the enclosed space 401. The occupant 403 is located at a first position 405a (shown in dashed lines) and a movement to a second position 405b is shown.

In this embodiment, the enclosed space air conditioning system 400 includes a plurality of air conditioning modules 402, with each air conditioning module 402 having a first cavity with an air direction mechanism therein and a second cavity, and a thermoelectric element located therebetween, as shown and described above. Each of the air conditioning modules 402 is connected to adjacent air conditioning modules 402 to form a ceiling of the enclosed space 401. The air conditioning modules 402 further include electronics packages as described above, including control elements and sensing or detecting elements, such as infrared sensors, proximity sensors, or other types of detection mechanisms as will be appreciated by those of skill in the art.

As schematically shown, the air conditioning modules 402 are supplied with air from one or more blowers 422 that are arranged at one side of the enclosed space air conditioning system 400. The blowers 422 are arranged to blow air into an air supply cavity 420 that fluidly connects the blowers 422 to the cavities of the air conditioning modules 402. In this particular embodiment, the blowers 422 blow air into the second cavity of the air conditioning modules 402 and the air direction mechanisms of the air conditioning modules 402 will pull air from the second cavity and blow such air into the enclosed space 401. As shown, the air supplied by the blowers 422 into the second cavity of the air conditioning modules 402 will exit or expel exhaust air 409 at an edge of the enclosed space air conditioning system 400 that is away from the blowers 422 (e.g., an opposing edge or side of the enclosed space air conditioning system 400).

As shown, when the occupant 403 is located at the first position 405a, a first air conditioning module 402a detects the occupant 403 and thus the air direction mechanism of the first air conditioning module 402a activates to supply conditioned air 407a directly to the occupant 403. Because there is only a single occupant within the enclosed space 401, only the first air conditioning module 402a is active, and all other air conditioning modules 402 are inactive. That is, the electronics packages of the other air conditioning modules 402 (excluding the first air conditioning module 402a) do not detect the presence of an occupant, and thus are not activated. Then, when the occupant 403 moves from the first position 405a to the second position 405b, the first air conditioning module 402a deactivates (no detection by the electronics package) and a second air conditioning module 402b activates (detection of the occupant 403 by the electronics package of the second air conditioning module 402b), and all other air conditioning modules 402 are inactive. As shown, the second air conditioning module 402b will supply conditioned air 407b directly to the occupant 403 when located at the second position 405b. As such, only the single air conditioning module 402 that detects the presence of an occupant will activate to provide conditioned air to the occupant.

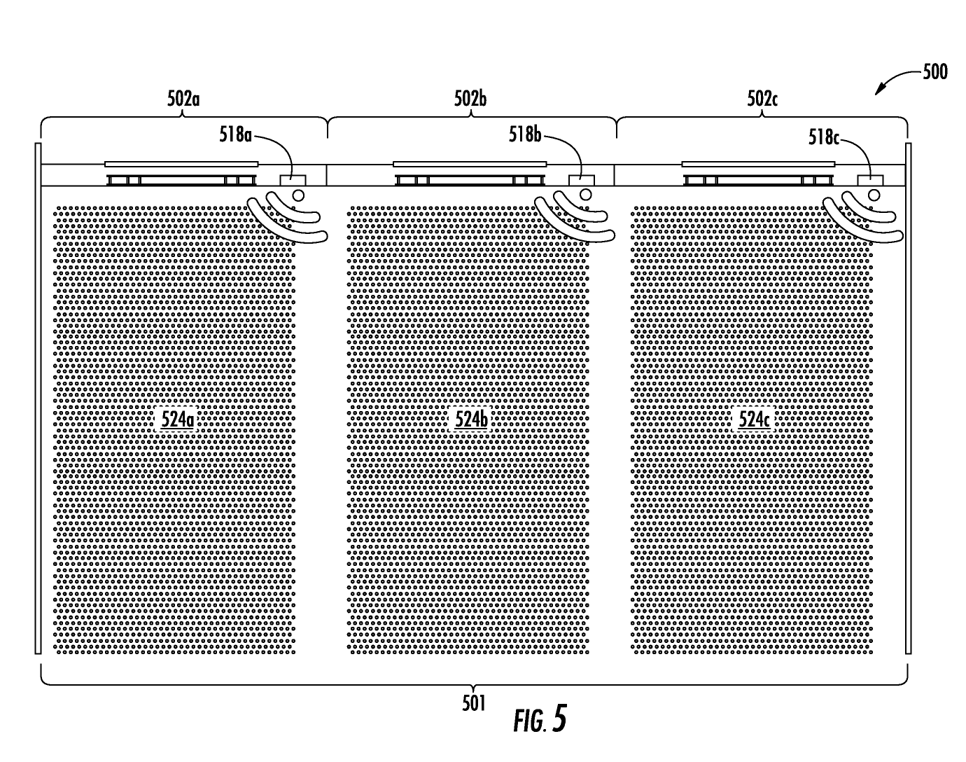

Turning now to FIG. 5, a schematic illustration of an enclosed space air conditioning system 500 arranged relative to an enclosed space 501 is shown. The enclosed space air conditioning system 500 forms a ceiling or a portion of a ceiling of the enclose space 501. The an enclosed space air conditioning system 500 includes a plurality of air conditioning modules 502a, 502b, 502c. The air conditioning modules 502a, 502b, 502c are similar to that shown and described above. However, in this embodiment, the air conditioning modules 502a, 502b, 502c only include the first enclosure (and first cavity therein). That is, there is no second enclosure on top of the first enclosure. The air direction mechanism of each air conditioning modules 502a, 502b, 502c is located within (or is part of, in the case of a vent arrangement) the first enclosure and pulls air from a space above the enclosed space air conditioning system 500 (e.g., a gap in a ceiling, an elevator shaft, etc.). Air pulled from external to the enclosed space air conditioning system 500 is pulled through or over the thermoelectric elements of the air conditioning modules 502a, 502b, 502c and blown (or pushed) toward a detected occupant by the air direction mechanism of the respective air conditioning module 502a, 502b, 502c.

As shown, each air conditioning module 502a, 502b, 502c includes an associated electronics package 518a, 518b, 518c. The electronics packages 518a, 518b, 518c include control components for controlling operation of the air direction mechanism and thermoelectric elements of the associated air conditioning module 502a, 502b, 502c. Further, as illustratively shown, the electronics packages 518a, 518b, 518c include sensing elements to detect the presence of an occupant within a respective detection zone 524a, 524b, 524c.

The sensing elements of the electronics packages 518a, 518b, 518c can be any type of detection device or technology as known in the art. For example, in some embodiments, the sensing element can be an optical sensor that detects the presence of an occupant within the respective detection zone 524a, 524b, 524c. Other types of proximity and/or detection devices can be used, such as thermal detectors, cameras, pressure sensors located in a floor below the respective air conditioning module 502a, 502b, 502c, etc. In other embodiments, a detection can be based, at least in part, upon a communication between a user device held by the occupant and the respective electronics package 518a, 518b, 518c. For example, a user may have a smart phone (a user device) that has a user profile with respect to personal preferences related to air temperature, humidity, air flow, etc. The user device may communicate with the closest electronics package by transmitting user preference information to the respective electronics package 518a, 518b, 518c thus activating the respective air conditioning module 502a, 502b, 502c to thus provide conditioned air in accordance with the user's preferences. User preference information can include, but is not limited to, temperature, airflow speed, and humidity. The electronics packages 518a, 518b, 518c may be configured such that only near-field or nearby electronics (user devices) can communicate therewith.

In some embodiments, the electronics packages can include networked building elements which can communicate with user devices to receive user preferences or other data (including detection of the presence of the user) and/or transmit information/data from the electronics package to the user device. Such communication between the electronics packages and user devices can include Bluetooth® Low Energy (BLE) technology, for example, and thus enable communication between the user devices and the air conditioning modules. In some embodiments, the air conditioning module may establish communication with one or more user devices that are outside of the structure/building. A specific location of a given user device can be determined using various techniques including, but not limited to, exchanging Global Positioning System (GPS) data, performing triangulation techniques, or signal strength detection, by way of non-limiting examples. Such technologies that allow communication can provide and the systems described herein to pre-treat or pre-condition a location in accordance with user preferences communicated from a user device. In example embodiments, the user devices communicate with the electronics packages over multiple independent wired and/or wireless networks. Embodiments are intended to cover a wide variety of types of communication between the user devices and the air conditioning modules of the present disclosure, and embodiments are not limited to the examples provided in this disclosure.

For example, communication can be made over a network of any type of known communication network including, but not limited to, a wide area network (WAN), a local area network (LAN), a global network (e.g. Internet), a virtual private network (VPN), a cloud network, and an intranet. The network may be implemented using a wireless network or any kind of physical network implementation known in the art. The user devices and/or the networked devices may be coupled to the air conditioning modules through multiple networks (e.g., cellular and Internet) so that not all user devices and/or the networked devices are coupled to the air conditioning modules through the same network. One or more of the user devices and the air conditioning modules can be connected to a network in a wireless fashion. In one non-limiting embodiment, the network is the Internet and one or more of the user devices execute a user interface application (e.g. a web browser) to communicate preferences to the air conditioning modules through the network. The network may also include a cloud-computing network that includes a cloud server configured to perform one or more functions of the air conditioning systems described herein.

In some embodiments, user preferences related to air quality can be communicated over one or more lines, connections, or networks, e.g., a request made by a user device and transmitted through the network to an enclosed space air conditioning system to request pre-conditioning of a portion of the enclosed space in accordance with the user preferences. The request for pre-conditioning may be initiated by a mobile device controlled by and/or associated with a user, in a passive or active manner. In some embodiments, the mobile device may be operative in conjunction with a Transmission Control Protocol (TCP) and/or a User Datagram Protocol (UDP). In some embodiments, a request for service (pre-conditioning) may be authenticated or validated based on a location of the user device. In some embodiments, a request for service may be fulfilled in accordance with one or more profiles, such as one or more user or mobile device profiles. In some embodiments the profiles may be registered as part of a registration process.

Further, in some embodiments, the enclosed space air conditioning system can communicate back to the user device to provide information to the user. For example, the enclosed space air conditioning system can transmit location or position information within the enclosed space that has been pre-conditioned to the user's preferences. The location and/or position information can include visual information provided on the user device and/or text/graphical information that indicates to the user the location that has been pre-conditioned in line with the user preferences. For example, in one non-limiting embodiment, the location and/or position information may provide a user with an indication or notification to stand at a particular location in an elevator car or sit in a particular chair in a conference room.

In some embodiments, when an occupant is detected within the detection zones 524a, 524b, 524c, the associated air conditioning module 502a, 502b, 502c can be activated (e.g., the air direction mechanism is turned on and/or the thermoelectric element is activated with a current). Thus, customized, directed, and localized air conditioning can be provided to specific locations and/or to locations that include an occupant, with all other air conditioning modules inactive.

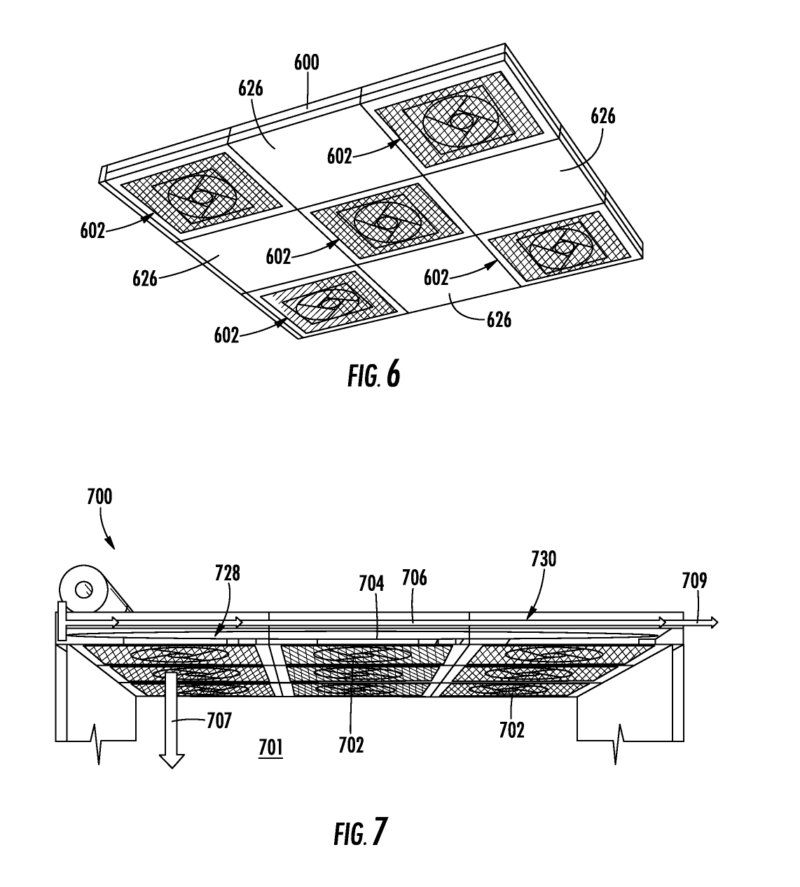

Turning now to FIG. 6, an alternative arrangement of an enclosed space air conditioning system 600 is schematically shown. The enclosed space air conditioning system 600 is substantially similar as that shown and described above, having a plurality of air conditioning modules 602, having electronics packages and air direction mechanisms for supplying customized, on-demand conditioned air at a specific location within an enclosed space. In this embodiment, however, an entire ceiling formed by the enclosed space air conditioning system 600 does not include a continuous arrangement of air conditioning modules 602. Rather, in this arrangement, connector modules 626 are arranged throughout the enclosed space air conditioning system 600. The connector modules 626 can be substantially similar to the air conditioning modules 602, but do not include a fan, electronics, etc. Further, in some embodiments, a surface of the connector modules 626 that faces an enclosed space can be solid to prevent air bleed into the enclosed space. The connector modules 626, however, can include one or more enclosures that align with the enclosure(s) of the air conditioning modules 602 to enable open spaces and air distribution to each and every air conditioning module 602.

Turning now to FIG. 7, a side view, schematic illustration of an enclosed space air conditioning system 700 in accordance with an embodiment of the present disclosure is shown. The enclosed space air conditioning system 700 includes a plurality of air conditioning modules 702 having features as described herein. In this embodiment, each of the air conditioning modules 702 includes a first enclosure 704 and a second enclosure 706, each defining a respective cavity. The first enclosure 704 does not have any barriers between adjacent air conditioning modules 702. The modules 702 are fluidly connected to allow for undisturbed air passage in the entire first enclosure 704. In some embodiments, the modules 702 are fluidly connected to allow for undisturbed air passage in a portion of the first enclosure 704. In one such embodiment, the first enclosure may be divided into one or more air flow zones. The same arrangement is applied in the second enclosure 706.

As air passes through the first cavity within the first enclosures 704 the air can be conditioned by a thermoelectric element of one or more of the air conditioning modules 702. In this illustration, cool air 728 is generated within the first enclosures 704 by interaction with one or more thermoelectric elements. The cool air 728 is then provided as conditioned air 707 into the enclosed space at a location proximate the active air conditioning module 702 (e.g., based on detection of an occupant near the active air conditioning module 702). As the air within the first enclosures 704 is cooled by the thermoelectric elements, air within the second enclosure(s) 706 is heated. That is, the air within the second enclosure(s) 706 may act as a heat sink and/or heat removal apparatus to improve cooling efficiency and/or effectiveness within the first enclosure(s) 704. Heated air 730 within the second enclosures 706 can then exit the second enclosure(s) 706 as exhaust air 709, which may vent into a space away from the enclosed space 701 (e.g., outside, into an elevator shaft, etc.).

In an example description, a matrix of thermoelectric elements are distributed in a ceiling space as part of air conditioning modules that form an enclosed space air conditioning system. The enclosed space air conditioning system is separated into two cavities defined by connected enclosures of the air conditioning modules. One of the surfaces of each thermoelectric element is exposed into the air flowing into and/or through a first enclosure (first cavity) and another of the surfaces of the thermoelectric element is exposed into the air flowing into and/or through a second enclosure (second cavity). The first enclosure is in the direct neighborhood (e.g., facing down) toward and/or into an enclosed space, such as an elevator car. Each air conditioning module may include an axial fan directly under the surface of the thermoelectric element and located within the first enclosure. A specific or particular air conditioning module of the enclosed space air conditioning system is activated when an occupant or other instruction is provided for activation, such as based on a sensors system (e.g., camera, thermal sensors, etc.). Detection of the presence of an occupant under a specific air conditioning module can trigger activation of that air conditioning module. When the occupant moves to a different location within the enclosed space, the active air conditioning element is turned off and another air conditioning module which detects the presence of the occupant is turned on.

In some embodiments, one or both of the surfaces of the thermoelectric elements can include thermal transfer features. For example, radiators may be attached to or part of the thermoelectric element such that improved thermal transfer between the thermoelectric element and adjacent air can be achieved. The thermal transfer features can be pins, fins, or other structures that extend from the surface of the thermoelectric element to increase a surface area of contact between the thermoelectric element and the air, as will be appreciated by those of skill in the art.

In accordance with some embodiments of the present disclosure, the enclosed space air conditioning systems can serve (simultaneously) a number of different occupants within an enclosed space. If an enclosed space is loaded close to capacity (e.g., an elevator car) then every air conditioning module can be activated (e.g., each module is independent and can operate simultaneously).

In another arrangement of enclosed space air conditioning systems of the present disclosure, the air direction mechanisms can be arranged as a slat, vent, or shutter arrangement. In such embodiments, rather than a dedicated fan, selective operation of the air conditioning modules can be achieved using openable vents or shutters that are associated with each air conditioning module. For example, a large blower or fan can provide airflow into one or more air conditioning modules of the enclosed space air conditioning system, and air can be directed into specific locations of the enclosed space by openable vents. For example, referring back to FIG. 3C, the air direction mechanism 310 may be replaced by a slatted, controllable vent or venting system with panels or slats that can open and close on command from a control operation of the electronics package 318. In a closed state, the vents can prevent air from passing from the air conditioning module and in an open state, conditioned air (conditioned by the thermoelectric element) can be directed into the enclosed space through the opened vents.

Advantageously, embodiments provided herein enable enclosed space air conditioning systems that are modular and able to provide custom and/or on-demand air conditioning to an occupant in proximity to a portion of the enclosed space air conditioning systems. Further, advantageously, embodiments provided herein can replace current air conditioning and ventilating systems in commercial and residential buildings and setting which rely upon air duct distribution (e.g., inefficient). Further, embodiments provided herein can enable energy savings through flexibility and adaptation to the occupation and individual needs within an enclosed space. Moreover, advantageously, modularity of construction of the enclosed space air conditioning systems is provided. For example, air conditioning modules of the present disclosure can be assembled by adding and/or connecting any number modules to achieve a desired arrangement.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. An enclosed space air conditioning system comprising:
at least one air conditioning module having an enclosure defining a cavity;
a thermoelectric element arranged within the cavity and configured to condition air within the cavity;
an air direction mechanism controllable to direct air from the cavity into an enclosed space; and
an electronics package configured to control the air direction mechanism and the thermoelectric element, the electronics package including a detection element configured to detect when an occupant in the enclosed space is in proximity of the at least one air conditioning module,
wherein the electronics package is configured to at least one of (i) activate at least one of the air direction mechanism and the thermoelectric element when the occupant is detected in proximity to the at least one air conditioning module, (ii) deactivate the activated air direction mechanism and/or thermoelectric element when the occupant is no longer detected in proximity to the at least one air conditioning module, and (iii) activate at least one of the air direction mechanism and the thermoelectric element to maintain an enclosed space preset condition.

2. The enclosed space air conditioning system of claim 1, wherein the air direction mechanism comprises at least one of (i) a fan located within the cavity and arranged to blow air out of the enclosure and into the enclosed space and (ii) a controllable vent forming a portion of the enclosure and arranged to open and close to enable air to pass from the cavity of the enclosure into the enclosed space.

3. The enclosed space air conditioning system of claim 1, wherein the at least one air conditioning module comprises a first air conditioning module and a second air conditioning module, wherein the first air conditioning module includes a first module enclosure having a first module air direction mechanism and a first module thermoelectric element within the first module enclosure and the second air conditioning module includes a second module enclosure having a second module air direction mechanism and a second module thermoelectric element within the second module enclosure.

4. The enclosed space air conditioning system of claim 3, wherein the first air conditioning module is connected to the second air conditioning module and wherein a first module cavity within the first module enclosure is fluidly connected to a second module cavity within the second module enclosure.

5. The enclosed space air conditioning system of claim 1, wherein the electronics package includes a temperature sensor arranged to detect an air temperature in proximity to the at least one air conditioning module.

6. The enclosed space air conditioning system of claim 1, further comprising a plurality of air conditioning modules.

7. The enclosed space air conditioning system of claim 6, wherein at least two air conditioning modules are connected to each other, wherein the connection between the at least two air conditioning modules at least one of electrically and communicatively connects the at least two air conditioning modules.

8. The enclosed space air conditioning system of claim 1, wherein the electronics package is located within the enclosure, wherein the electronics package includes a proximity detector arranged to detect a presence of an occupant in proximity of the proximity detector.

9. The enclosed space air conditioning system of claim 1, wherein the electronics package includes a communication device arranged to at least one of communicate with a user device and detect the user device.

10. The enclosed space air conditioning system of claim 9, wherein the electronics package receives user preferences from the user device and is configured to transmit a location or position to the user device to indicate a location or position within the enclosed space that is pre-conditioned in accordance with the user preferences.

11. The enclosed space air conditioning system of claim 1, wherein the air conditioning module includes a second enclosure arranged on an opposing side of the enclosure when the enclosure is installed relative to the enclosed space, the second enclosure defining a second cavity therein.

12. The enclosed space air conditioning system of claim 11, wherein the thermoelectric element has a surface exposed to the cavity and a surface exposed to the second cavity.

13. The enclosed space air conditioning system of claim 11, wherein at least one of the surfaces of the thermoelectric element includes thermal transfer features arranged to increase a thermal transfer between the thermoelectric element and air.

14. The enclosed space air conditioning system of claim 1, further comprising an air supply cavity fluidly connected to the cavity to supply air into the cavity of the enclosure.

15. The enclosed space air conditioning system of claim 14, further comprising a blower connected to the air supply cavity, wherein the blower is operable to blow air into the cavity.

16. An enclosed space comprising:
an enclosed space air conditioning system forming at least a portion of a ceiling of the enclosed space, wherein the enclosed space air conditioning system comprises:
at least one air conditioning module having an enclosure defining a cavity;
a air direction mechanism located arranged to direct air out of the enclosure and into an enclosed space;
a thermoelectric element arranged within the cavity and configured to condition air within the cavity; and
an electronics package configured to control the air direction mechanism and the thermoelectric element, the electronics package including a detection element configured to detect when an occupant in the enclosed space is in proximity of the at least one air conditioning module,
wherein the electronics package is configured to at least one of (i) activate at least one of the air direction mechanism and the thermoelectric element when the occupant is detected in proximity to the at least one air conditioning module, (ii) deactivate the activated air direction mechanism and/or thermoelectric element when the occupant is no longer detected in proximity to the at least one air conditioning module, and (iii) activate at least one of the air direction mechanism and the thermoelectric element to maintain an enclosed space preset condition.

17. The enclosed space of claim 16, wherein the enclosed space is a cab of an elevator car.

18. The enclosed space of claim 16, wherein the enclosed space air conditioning system comprises a plurality of air conditioning modules.

19. The enclosed space of claim 18, wherein each air conditioning module includes a dedicated electronics package located within the enclosure of the air conditioning module.

20. The enclosed space of claim 16, wherein detection of the occupant comprises communication between the electronics package and a user device of the occupant, wherein personal preferences are received at the electronics package and the electronics package controls the at least one air conditioning module to condition air in accordance with the personal preferences.
